(19) United States
(12) Patent Application Publication
(10) Pub. No.: US 2026/0217578 A1
(43) Pub. Date: Jul. 30, 2026

(54) Arrangement and method for treatment of water in a vessel for culture of marine organisms

(71) Applicant: SEARAS AS, Bergen (NO)

(72) Inventors: Morten Aga, Bergen (NO); Eldar Lien, Bergen (NO)

(73) Assignee: SEARAS AS, Bergen (NO)

(21) Appl. No.: 19/151,702

(22) PCT Filed: Feb. 5, 2024
(86) PCT No.: PCT/NO2024/000001

§ 371 Date: Jul. 29, 2025

(30) Foreign Application Priority Data
Feb. 6, 2023 (NO) 20230094

(51) Int. Cl. C02F 1/72; A01K 63/00; A01K 63/04; B01D 19/00; C02F 1/00; C02F 1/20; C02F 101/10; C02F 103/20

(52) U.S. Cl. CPC C02F 1/727; A01K 63/003; A01K 63/042; B01D 19/00; C02F 1/006; C02F 1/20; C02F 2101/10; C02F 2103/20; C02F 2301/046; C02F 2301/063

(57) ABSTRACT

An arrangement and method for treatment of water in a vessel for culture of marine organisms is disclosed. The arrangement comprises a vessel (12) and at least two separate chambers (14) arranged inside of outside of the vessel. A pipe (16) is arranged to sequentially conduct, and simultaneously, treat water from the vessel (12) to a first and second chamber (14) and then back to the vessel (12). Water in the pipe is subjected to negative pressure by a suitable device to transfer the water between the vessel (12) and chambers (14), and gas is added to the pipe (16).

### FIELD OF THE INVENTION

The present invention relates to a device and method for treating liquid in a tank.

### BACKGROUND OF THE INVENTION

The rapidly growing world population requires increased production of marine proteins. With the environmental challenges associated with open-sea farming of marine species today, more and more production will need to take place in closed tanks or tanks both on land and at sea. There is currently competition for space that can be used for farming both on land and at sea, and there is also a significant challenge in reducing the energy demand for farming in closed facilities.

### PURPOSE OF THE INVENTION

An object of the present invention is to find a solution for effective water treatment in a tank or container.

It is thus an object of the present invention to provide a solution for water treatment in a tank, whether this is a tank for farming marine species, or it is a tank for wastewater to be treated.

By a closed tank is meant here a container or tank that is closed against the surroundings at the bottom and on the edges, as opposed to a conventional fish cage which has an open net structure against the surroundings, such as the sea.

It is further an object of the present invention to provide a solution for water treatment in tanks that do not have a center column.

Yet another object of the invention is to easily increase the degree of purification of water in existing tanks that have low capacity for water purification by taking in water from openings in the tank wall, treating it, and returning it through openings at another location in the tank wall.

### DISCUSSION OF PRIOR ART

The solution according to the present invention is well suited for use with a tubular water treatment device, as described in PCT/NO202/050108, which is a unit that transports water from one location to another, under negative pressure, where the water is gassed to exchange gases, and particles are also removed during this transport. Thus, the solution represents a new way to integrate such a tubular water treatment device, as described in PCT/NO202/050108, into a tank.

### SUMMARY OF THE INVENTION

To achieve the most energy-efficient water purification, it is crucial to avoid moving the water out of the tank for treatment and then pumping it back into the tank again. Such water movement requires a lot of energy. Many of the tanks used today are often polygonal tanks with straight side walls because they are inexpensive to produce in concrete and steel. They are space-efficient because they can be placed side by side, thus utilizing available space better than using round tanks. Octagonal tanks are therefore widely used as they provide a good flow pattern for the circulating water in the tank while being space efficient. Square tanks provide a poor flow pattern, as stagnant water with particle accumulation occurs in the corners. Round tanks provide the best flow pattern but are not as space efficient.

The present invention thus relates, in a first aspect, to a device for treating water in a tank, characterized in that the tank comprises a main chamber for farming marine organisms, and additionally two or more separate chambers ( ) arranged for treating the water in the tank, and that between two separate chambers, a pipeline is arranged, and where the water in the tank is led to a first chamber and then further through the pipeline to a second chamber, and then the water is returned to the tank, and where the pipeline is used to treat the water, where pressure-reducing means are used to establish a negative pressure in the pipeline, and a gas or air is added to the pipeline.

In one embodiment, water is transported under negative pressure in a pipeline from a chamber at the tank edge to another chamber at the tank edge, where the intake is through fittings to an external chamber or directly from the external tank wall, and the outlet back into the tank is from an external tank volume with an opening into the tank, or directly from the external tank wall, gas is added to the pipe, and a vacuum pump sucks out added gas to maintain the negative pressure in the pipe.

In one embodiment, the separate chambers are positioned inside relative to the tank wall of the main chamber.

In one embodiment, the separate chambers are positioned outside relative to the tank wall of the main chamber.

In one embodiment, one or more chambers are positioned inside, and one or more chambers are positioned outside relative to the tank wall of the main chamber.

In one embodiment, the water in the pipeline is circulated by a pump device or a gas lift.

In one embodiment, the pump device is located in the tank wall where the water returns to the tank.

In one embodiment, air is added at the bottom along the length of the pipe and sucked out at one or more suction ports along the top of the pipeline.

In one embodiment, air is added in the form of bubbles where the bubble size is selected based on the type of particles and gases to be removed from the water.

In one embodiment, the tank is a polygonal tank.

In one embodiment, the tank is an octagonal tank.

In one embodiment, the tank is circular.

In one embodiment, the pipeline is a closed channel.

In one embodiment, the pipeline is an integrated structural part of the tank edge.

In one embodiment, the pipe system goes from an external volume to another external volume in a tank where the water is led in and out of the tank wall through openings.

In one embodiment, the pipeline goes from one tank to another tank, and corresponding pipes return the same amount of water to the original tank.

In one embodiment, oxygen is added to the volume before the water enters the tank.

In one embodiment, a cyclone separates liquid and gas in the pipeline, where the gas exits through the vacuum pump, while the liquid goes to drainage.

In one embodiment, the external volumes/chambers are divided into 2 parts, each with inlet and outlet.

In a second aspect, the present invention relates to a method for water treatment in a tank, where water is transported under negative pressure in a pipeline from one location at the tank edge to another location at the tank edge, characterized in that the intake is through fittings to an external tank volume or directly from the external tank wall, the outlet is from an external tank volume with an opening into the tank, gas is added to the pipeline, and a vacuum pump sucks out added gas to maintain the negative pressure in the pipe.

In one embodiment, the water is returned to the tank through openings in the tank wall by a circulation pump.

In one embodiment, oxygen is added to the water volume before the water enters the tank.

### DESCRIPTION OF FIGURES

FIG. 1 schematically illustrates an octagonal tank where each of the four corners has four separate external volumes. These separate chambers communicate with the octagonal tank itself for intake and discharge of water to the tubular water treatment devices (two tubular water treatment devices are shown in the figure). The intake to the external separate chamber can be an open field with a grid to prevent fish from swimming in, or it can be smaller point intakes. Similarly, the return of water to the tank can be openings designed to achieve the desired flow pattern.

FIG. 2 schematically shows an octagonal tank with 4 tubular water treatment devices with intake and discharge in corner volumes. Each of the 4 corner volumes is divided by a partition from the main chamber where marine species are farmed.

FIG. 3 schematically shows the direction of water flow through a tubular water treatment device where water intake is indicated by red arrows. A pump device is used to return water to the tank, indicated by blue arrows.

FIG. 4 schematically shows an octagonal tank with external volumes for intake and discharge of water to the tubular water treatment devices. The chambers are shown as cylindrical tanks.

FIG. 5 schematically shows a circular tank with tubular water treatment devices along the edge and with intake and discharge volumes for water arranged externally on the tank wall.

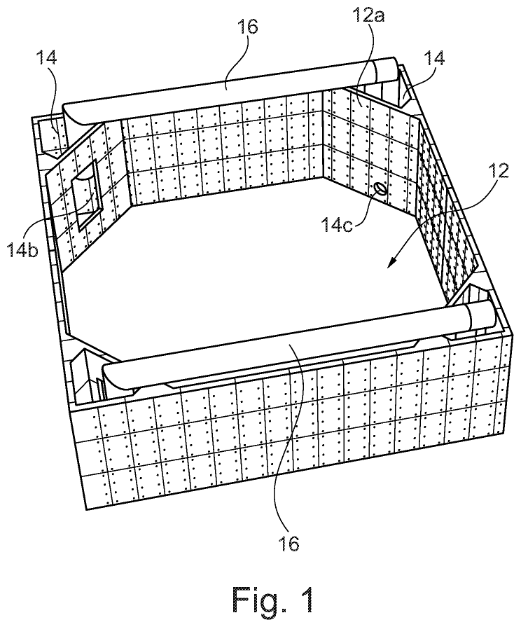

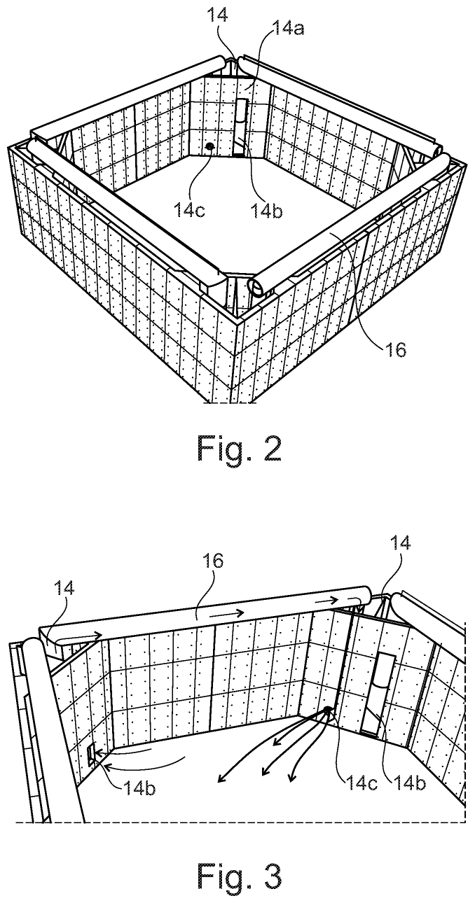

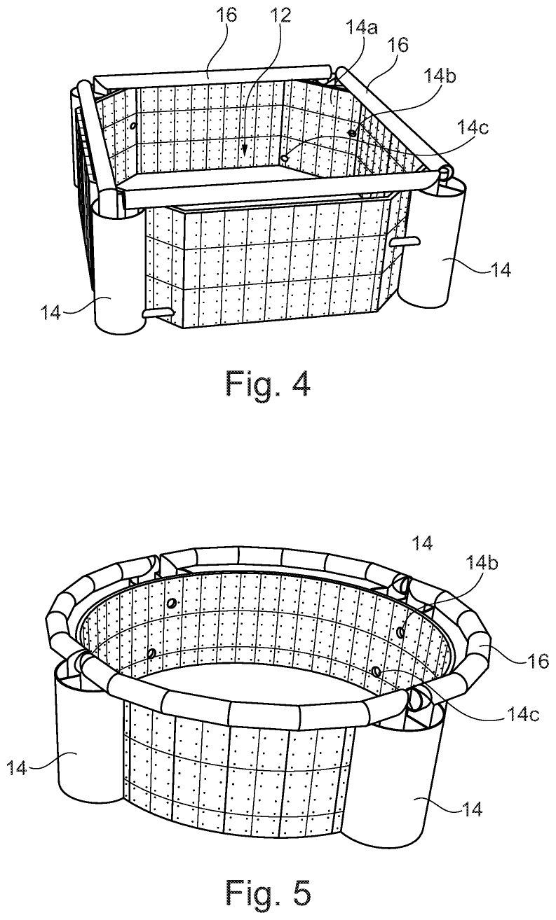

The solution described is particularly suitable for octagonal tanks 12, but can be used for tanks with 3 or more sides 12a. In a preferred embodiment, the tank is octagonal and the external space formed in the corners 12b is utilized by extending the side edges so that the octagonal tank becomes square (see FIG. 1). This creates 4 external separate corner volumes 14 used for intake 14b and discharge 14c for tubular water treatment devices 16. In an octagonal tank 12, there will then be 2 tubular water treatment devices 16. By dividing the corner volumes 14 into 2 parts with a wall, in an octagonal tank 12, 4 tubular water treatment devices 16 can be accommodated, as shown in FIGS. 2 and 4, lying along the edge 12a or as an integrated part of the edge 12a of the tank 12. This way, an area-efficient solution that is also energy-efficient can be achieved.

When water is transported through a tubular water treatment device 16 under reduced pressure (vacuum) and gases are added to exchange gases dissolved in the liquid, the water in the corner volume 14 where the outlet 14c is located will have a gas saturation <100%, e.g., typically 90%. The solution according to the invention can thus effectively, for example, be used to add oxygen to these outlet volumes. After a period of farming marine organisms, the water is undersaturated with gas (oxygen) and oxygenation of the water will then occur rapidly, resulting in water with 100% gas saturation again, but with >100% oxygen saturation, e.g., 130%.

Transfer of water into and out of the corner volumes/chambers 14 can occur through openings in the chamber walls 14a, for example, as holes 14b, 14c covered with perforated grates to prevent fish from swimming in. There may be one or more holes 14b, 14c, or the partition 14a may be a larger perforated section. The outlet 14c back to the tank 12 can be a pipe (part of 16) angled in such a way as to contribute to good water circulation in the tank 12. In this pipe, a pump device 18 can also be placed. This pump device 18 ensures the necessary water flow through the tubular water treatment devices 16.

Tests have shown that a tubular water treatment device with a diameter of 1.2 m and a length of 11 m will be able to transport 20 m3 of water per minute with an energy consumption of 11.5 kWh, where 1.5 kWh is used for the circulation pump and 10 kWh is used for water degassing. The water will then have a reduction in CO₂ of 50%, and a TGP of 91% at the outlet 14c. By adding O₂ to the outlet volume, one typically achieves 130% oxygen saturation with a TGP of 100%.

The present invention provides a way to integrate a tubular water treatment device 16 into a tank 12 that has proven to be an area-efficient and energy-efficient solution. The solution is particularly suitable for use in polygonal tanks.

It can also be used in round tanks, but then the corner volumes must be designed as semicircles on the outside of the tank or as freestanding tanks. This will not be as area-efficient, but at least equally energy-efficient. The tubular water treatment device can be an integrated part of the top edge of the tank, or it can lie on or along the tank edge or as a secant over the tank.

We would also like to emphasize that the present invention is very well suited for tanks that do not have a central column, and that the solution can function as additional equipment in existing tanks.

1. Device for water treatment in a tank, wherein the tank comprises a main chamber for the farming of marine organisms, and additionally two or more separate chambers arranged for the treatment of water in the tank, and that between two separate chambers a pipeline is arranged, and where the water in the tank is led to a first chamber and then further through the pipeline and to a second chamber and then the water is returned to the tank, and where the pipeline is used to treat the water, where pressure-reducing means are used to establish a vacuum in the pipeline and a gas or air is added to the pipeline.

2. The device according to claim 1, wherein water is transported in a vacuum in a pipeline from a chamber at the tank edge to another chamber at the tank edge, where the intake is through openings to an external chamber or directly from the external tank wall, and that the outlet back into the tank is from an external tank volume with an opening into the tank, or directly from the external tank wall, gas is added to the pipe, and a vacuum pump sucks out added gas to maintain the vacuum in the pipe.

3. The device according to claim 1, wherein the separate chambers are positioned inside in relation to the tank wall of the main chamber.

4. The device according to claim 1, wherein the separate chambers are positioned outside in relation to the tank wall of the main chamber.

5. The device according to claim 3, wherein one or more chambers are positioned inside, and one or more chambers are positioned outside in relation to the tank wall of the main chamber.

6. The device according to claim 1, wherein the water is circulated in the pipeline by means of a pump device or a gas lift.

7. The device according to claim 6, wherein the pump device is located in the tank wall where the water returns to the tank.

8. The device according to claim 1, wherein air is added at the bottom along the length of the pipe and is sucked out at one or more exhausts along the top of the pipeline.

9. The device according to claim 1, wherein air is added in the form of bubbles, where the bubble size is chosen based on the type of particles and gases to be removed from the water.

10. The device according to claim 1, wherein the tank is a polygonal tank or an octagonal tank or is circular.

11-12. (canceled)

13. The device according to claim 1, wherein the pipeline is a closed channel.

14. The device according to claim 1, wherein the pipeline is an integrated structural part of the tank edge.

15. The device according to claim 1, wherein the pipe system goes from an external volume to another external volume in a tank where the water is led in and out of the tank wall through openings.

16. The device according to claim 1, wherein the pipeline goes from one tank to another tank, and where corresponding pipes return the same amount of water to the original tank.

17. The device according to claim 1, wherein oxygen is added in the volume before the water enters the tank.

18. The device according to claim 1, wherein a cyclone separates liquid and gas in the pipeline, where the gas exits through the vacuum pump, while the liquid goes to drainage.

19. The device according to claim 15, wherein the external volumes are divided into 2 parts with inlet and outlet.

20. A method for water treatment in a tank, where water is transported in a vacuum in a pipeline from a location at the tank edge to another location at the tank edge, wherein the intake is through openings to an external tank volume or directly from the external tank wall, the outlet is from an external tank volume with an opening into the tank, and gas is added to the pipeline, and a vacuum pump sucks out added gas to maintain the vacuum in the pipe.

21. The method according to claim 20, wherein the water is returned to the tank through openings in the tank wall by a circulation pump.

22. The method according to claim 20, wherein oxygen is added to the water volume before the water enters the tank.
